(19) United States
(12) Patent Application Publication
(10) Pub. No.: US 2025/0188960 A1
(43) Pub. Date: Jun. 12, 2025

(54) VALVE BLOCK, AND MULTI-CONTROL VALVE DEVICE HAVING SAME

(71) Applicant: KAWASAKI JUKOGYO KABUSHIKI KAISHA, Kobe-shi, Hyogo (JP)

(72) Inventors: Masahiro OHIRA, Kobe-shi (JP); Ryo KAWAKAMI, Kobe-shi (JP); Koji YAMASAKI, Kobe-shi (JP)

(21) Appl. No.: 18/845,617

(22) PCT Filed: Oct. 18, 2022
(86) PCT No.: PCT/JP2022/038809

§ 371 Date: Sep. 10, 2024

(30) Foreign Application Priority Data
Mar. 15, 2022 (JP) 2022-040390

(51) Int. Cl. F15B 13/04; F15B 13/02

(52) U.S. Cl. CPC F15B 13/0401; F15B 13/024; F15B 13/026; F15B 13/027

(57) ABSTRACT

This valve block is a valve block in a multi-control valve device in which a plurality of valve blocks are arranged in a predetermined direction and includes: a block body; a first check valve and a second check valve each of which allows a working fluid flowing in the block body to flow in one direction and blocks the working fluid from flowing in the opposite direction; and a pressure compensation valve that compensates for the pressure of the working fluid flowing in the block body. The block body includes a first side surface facing one way in a first direction perpendicular to the predetermined direction. The first check valve, the second check valve, and the pressure compensation valve are inserted through the first side surface of the block body so as to be parallel to each other.

### TECHNICAL FIELD

The present invention relates to a valve block in a multi-control valve device in which a plurality of valve blocks are arranged in a predetermined direction, and the multi-control valve device including the valve block.

### BACKGROUND ART

Industrial equipment such as construction equipment includes a multi-control valve device that controls the flow of a working fluid to each of a plurality of hydraulic cylinders. Examples of known multi-control valve devices include the multi-control valve device disclosed in Patent Literature (PTL) 1. In the multi-control valve device disclosed in PTL 1, a plurality of valve blocks are arranged in a predetermined direction. The valve block includes a block body and a directional control valve. The directional control valve is inserted through the block body. In the valve block, the directional control valve operates to control the flow of the working fluid.

### CITATION LIST

### Patent Literature

PTL 1: Japanese Laid-Open Patent Application Publication No. 2021-092227

### SUMMARY OF INVENTION

### Technical Problem

In the multi-control valve disclosed in PTL 1, the valve block may include the following valves in addition to the directional control valve. For example, the valve block includes two check valves and a pressure compensation valve. In the valve block, the working fluid flowing from the two check valves is brought to the pressure compensation valve after streams of the working fluid merge together. The two check valves and the pressure compensation valve are inserted through the block body. It is desirable that the block body through which the two check valves and the pressure compensation valve are inserted be made compact.

Thus, an object of the present invention is to provide a valve block in which a block body through which two check valves and a pressure compensation valve are inserted can be made compact.

### Solution to Problem

A valve block according to the present invention is a valve block in a multi-control valve device in which a plurality of valve blocks are arranged in a predetermined direction and includes: a block body; a first check valve and a second check valve each of which allows a working fluid flowing in the block body to flow in one direction and blocks the working fluid from flowing in an opposite direction; and a pressure compensation valve that compensates for a pressure of the working fluid flowing in the block body, and the block body includes a first side surface facing one way in a first direction perpendicular to the predetermined direction, and the first check valve, the second check valve, and the pressure compensation valve are inserted through the first side surface of the block body so as to be parallel to each other.

According to the present invention, the first check valve, the second check valve, and the pressure compensation valve are inserted through the first side surface of the block body so as to be parallel to each other. Therefore, the block body can be made compact in the predetermined direction. Furthermore, the first check valve, the second check valve, and the pressure compensation valve are kept from interfering with another valve block adjacent thereto in the predetermined direction.

A multi-control valve device according to the present invention includes a plurality of valve blocks including the aforementioned valve block, and the plurality of valve blocks are arranged in the predetermined direction so as to be adjacent to each other.

According to the present invention, it is possible to implement a multi-control valve device including the aforementioned functions.

### Advantageous Effects Of Invention

According to the present invention, a block body through which two check valves and a pressure compensation valve are inserted can be made compact.

The above object, other objects, features, and advantages of the present invention will be made clear by the following detailed explanation of preferred embodiments with reference to the attached drawings.

### BRIEF DESCRIPTION OF DRAWINGS

FIG. 1 is a perspective view illustrating a multi-control valve device including valve blocks according to the present invention.

FIG. 2 is a perspective view of a valve block according to the present invention as viewed from above.

FIG. 3 is a circuit diagram illustrating a hydraulic circuit formed in the valve block illustrated in FIG. 2.

FIG. 4 is a front view of the valve block illustrated in FIG. 2, as viewed from the front.

FIG. 5 is a right side view of the valve block illustrated in FIG. 2, as viewed from the right side.

FIG. 6 is a left side view of the valve block illustrated in FIG. 2, as viewed from the left side.

FIG. 7 is a plan view of the valve block illustrated in FIG. 2, as viewed from above.

FIG. 8 is a cross-sectional view of the valve block illustrated in FIG. 4, as cut along cut line VIII-VIII.

FIG. 9 is a cross-sectional view of the valve block illustrated in FIG. 4, as cut along cut line IX-IX.

FIG. 10 is a cross-sectional view of the valve block illustrated in FIG. 7, as cut along cut line X-X.

FIG. 11 is a cross-sectional view of the valve block illustrated in FIG. 7, as cut along cut line XI-XI.

FIG. 12 is a cross-sectional view of the valve block illustrated in FIG. 7, as cut along cut line XII-XII.

FIG. 13 is a bottom view of the valve block illustrated in FIG. 2, as viewed from below.

### DESCRIPTION OF EMBODIMENTS

Hereinafter, a multi-control valve device 1 according to an embodiment of the present invention and a valve block 2 included in the multi-control valve device 1 will be described with reference to the aforementioned drawings. Note that the concept of directions mentioned in the following description is used for the sake of explanation; the orientations, etc., of elements according to the invention are not limited to these directions. The multi-control valve device 1 and the valve block 2 described below are merely one embodiment of the present invention. Thus, the present invention is not limited to the embodiments and may be subject to addition, deletion, and alteration within the scope of the essence of the invention.

### Multi-control Valve Device

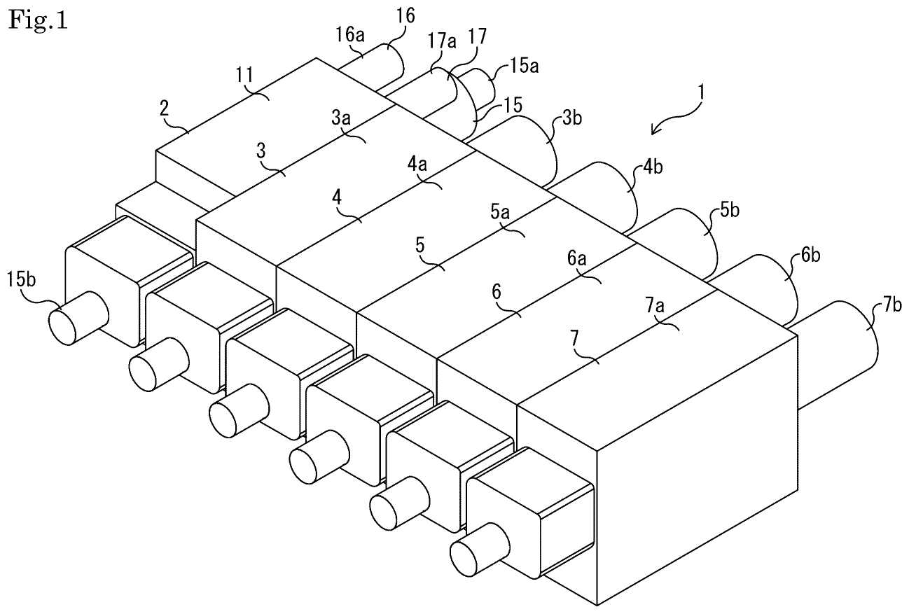

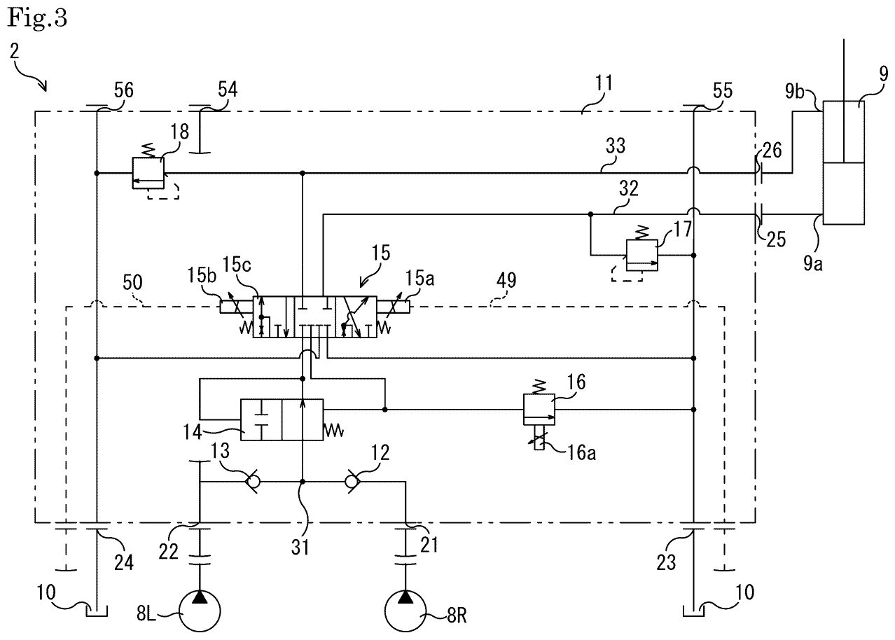

The multi-control valve device 1 illustrated in FIG. 1 is included in hydraulic equipment including industrial equipment such as construction equipment. The multi-control valve device 1 controls the flow (the direction and the flow rate in the present embodiment) of a working fluid (for example, pressure oil or water). More specifically, the multi-control valve device 1 is connected to a plurality of pumps 8L, 8R (refer to FIG. 3 to be described later) and a plurality of actuators (not illustrated in the drawings). In the present embodiment, the multi-control valve device 1 is connected to the two pumps 8L, 8R. By controlling the flow of the working fluid discharged from the pumps 8L, 8R, the multi-control valve device 1 supplies and drains the working fluid to and from the plurality of actuators. The multi-control valve device 1 includes a plurality of valve blocks 2 to 7. In the present embodiment, the multi-control valve device 1 includes six valve blocks 2 to 7. Note that the number of valve blocks included in the multi-control valve device 1 is not limited to six and may be at most five or at least seven. The six valve blocks 2 to 7 are arranged side by side in a predetermined direction so as to be adjacent to each other. The five valve blocks 3 to 7 are configured as follows, for example.

Specifically, the five valve blocks 3 to 7 include block bodies 3a to 7a and directional control valves 3b to 7b. Each of the block bodies 3a to 7a is formed in the shape of a rectangular parallelepiped having a thickness in the predetermined direction, for example. In other words, the block bodies 3a to 7a each include a principal surface and a rear surface in the predetermined direction. Furthermore, the block bodies 3a to 7a each include side surfaces in first and second directions perpendicular to the predetermined direction. The first direction and the second direction cross each other. In the present embodiment, the first direction and the second direction are perpendicular to each other. In FIG. 1, the predetermined direction is a depth direction. The first direction is the height direction in FIG. 1, and the second direction is the width direction in FIG. 1.

The directional control valves 3b to 7b is connected to the pumps 8L, 8R and the actuators. The directional control valves 3b to 7b control the flow of the working fluid flowing from the pumps 8L, 8R to the actuators. The directional control valves 3b to 7b are inserted through the block bodies 3a to 7a, respectively. More specifically, the directional control valves 3b to 7b penetrate the block body 3a in the second direction. Both end portions of each of the directional control valves 3b to 7b protrude on one side and the other side in the second direction from both side surfaces of a corresponding one of the block bodies 3a to 7a that are located in the second direction. The directional control valves 3b to 7b, which are electromagnetic spool valves in the present embodiment, include solenoid proportional control valves on the protruding portions, for example.

### Valve Block

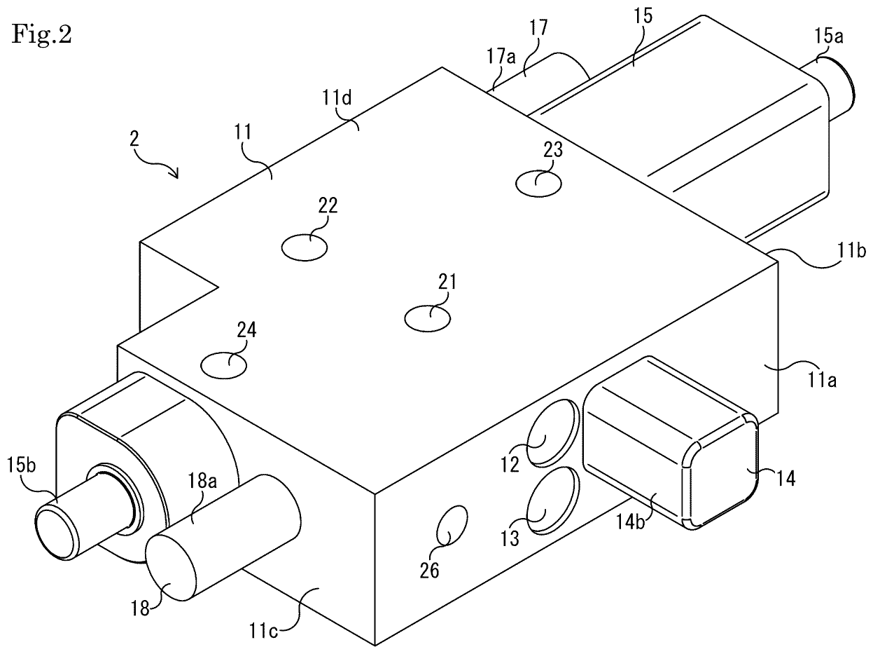

The valve block 2, which is an embodiment of the present invention, is configured as follows. Specifically, the valve block 2 includes a block body 11, two check valves 12, 13, and a pressure compensation valve 14, as illustrated in FIG. 2. Furthermore, the valve block 2 includes a directional control valve 15, a solenoid relief valve 16, and a pair of relief valves 17, 18. In the following description, the predetermined direction is the height direction in FIG. 2, the first direction is the depth direction in FIG. 2, and the second direction is the horizontal direction in FIG. 2. The valve block 2 is connected to the two pumps 8L, 8R and an actuator 9 (refer to FIG. 3). More specifically, the valve block 2 is connected to the two pumps 8L, 8R via other valve blocks 3 to 7. In the valve block 2, the working fluid brought from the two pumps 8L, 8R flows in the block body 11. In the block body 11, streams of the working fluid from the two pumps 8L, 8R merge together. The valve block 2 controls the flow of the merged streams of the working fluid to the actuator 9. At this time, the valve block 2 supplies the working fluid to the actuator 9 at a flow rate corresponding to an input control signal regardless of a load. With reference to FIG. 3, the following will first describe a hydraulic circuit formed in the valve block 2.

In the block body 11, two inlet ports 21, 22, two tank ports 23, 24, and two supply/drainage ports 25, 26 are formed. Furthermore, in the block body 11, passages 41 to 48 and a merging chamber 31, which will be described in detail later, are formed, and the working fluid flows in the block body 11.

The first inlet port 21 is connected one pump 8R among the two pumps 8L, 8R, and the second inlet port 22 is connected to the other pump 8L among the two pumps 8L, 8R. In the present embodiment, the two inlet ports 21, 22 are connected to the pumps 8L, 8R via passages (not illustrated in the drawings) formed in other valve blocks 3a to 7a. The two tank ports 23, 24 are connected to a tank 10. In the present embodiment, the two tank ports 23, 24 are also connected to the tank 10 via the passages formed in other valve blocks 3a to 7a. The first and second supply/drainage ports 25, 26 are connected to ports 9a, 9b of the actuator 9. The actuator 9 is a hydraulic cylinder 9, for example, and the supply/drainage port 25 and the supply/drainage port 26 are connected to a head-end port 9a and a rod-end port 9b, respectively. Note that the actuator 9 may be a hydraulic motor. Note that the supply/drainage port 25 and the supply/drainage port 26 may be connected to the rod-end port 9b and the head-end port 9a, respectively.

In the block body 11, the working fluid is introduced into the block body 11 through the first and second inlet ports 21, 22. The first and second supply/drainage ports 25, 26 supply and drain the working fluid to and from the hydraulic cylinder 9. Specifically, the introduced working fluid flows in the block body 11 and is supplied to the hydraulic cylinder 9 via one of the supply/drainage ports 25, 26. In the hydraulic cylinder 9, the working fluid is drained from the other of the supply/drainage ports 25, 26. The working fluid to be drained flows in the block body 11 and is drained to the tank 10 via the tank ports 23, 24.

### Check Valve

The first check valve 12 and the second check valve 13 are connected to the first inlet port 21 and the second inlet port 22, respectively. Furthermore, the first check valve 12 and the second check valve 13 are connected to the merging chamber 31, which will be described in detail later. The first and second check valves 12, 13 allow the working fluid flowing in the block body 11 to flow in one direction and blocks the working fluid flowing in the block body 11 from flowing in the opposite direction. More specifically, the first check valve 12 allows the working fluid to flow in one direction from the first inlet port 21 to the merging chamber 31 and blocks the working fluid from flowing in the opposite direction. Meanwhile, the second check valve 13 allows the working fluid to flow in one direction from the second inlet port 22 to the merging chamber 31 and blocks the working fluid from flowing in the opposite direction. Thus, streams of the working fluid flowing from the inlet ports 22 merge together in the merging chamber 31.

### Pressure Compensation Valve

The pressure compensation valve 14 is connected to the merging chamber 31. In the present embodiment, the pressure compensation valve 14 is inserted through the merging chamber 31. Furthermore, the pressure compensation valve 14 is connected to the directional control valve 15. The pressure compensation valve 14 compensates for the pressure of the working fluid flowing in the block body 11. More specifically, the pressure compensation valve 14 adjusts an opening degree thereof so that the upstream-downstream pressure difference (that is, the difference between the upstream pressure and the downstream pressure) of the directional control valve 15, which will be described in detail later, becomes constant. In the present embodiment, the pressure compensation valve 14 receives the upstream pressure and the downstream pressure of the directional control valve 15 in directions against each other. The pressure compensation valve 14 adjusts the opening degree according to the difference between the upstream pressure and the downstream pressure that are acting thereon.

### Directional Control Valve

The directional control valve 15 is connected a tank port 23 and the two supply/drainage ports 25, 26 in addition to the pressure compensation valve 14. The directional control valve 15 controls the flow direction of the working fluid flowing in the block body 11. In the directional control valve 15, which is a solenoid spool valve, for example, a spool 15c moves in a direction corresponding to an input control signal. Accordingly, the pressure compensation valve 14 is connected to one of the two supply/drainage ports 25, 26, and the other is connected to one of the tank ports 23, 24. In the present embodiment, the directional control valve 15 connects the first supply/drainage port 25 and the first tank port 23 at the time of connecting the first supply/drainage port 25 to the tank 10, and connects the second supply/drainage port 26 and the second tank port 24 at the time of connecting the second supply/drainage port 26 to the tank 10. The directional control valve 15 is an electric spool valve, for example. The spool 15c of the directional control valve 15 moves with a stroke length corresponding to the input control signal. Thus, the opening degree of the directional control valve 15 is adjusted according to the input control signal.

In this manner, according to the input control signal, the directional control valve 15 switches the connection destination of the pressure compensation valve 14 between the supply/drainage ports 25, 26. This allows the directional control valve 15 to supply the working fluid to the hydraulic cylinder 9 in a direction corresponding to the input control signal. Thus, the hydraulic cylinder 9 extends and retracts in the direction corresponding to the input control signal. Furthermore, the directional control valve 15 adjusts the opening degree thereof according to the input control signal, thereby controlling the speed of extension and retraction of the hydraulic cylinder 9.

### Solenoid Relief Valve

The solenoid relief valve 16 is connected to the pressure compensation valve 14 and the tank port 23. The solenoid relief valve 16 drains, to the tank 10 (the tank port 23 in the present embodiment), the downstream pressure of the directional control valve 15 that acts on the pressure compensation valve 14. More specifically, according to an input relief signal, the solenoid relief valve 16 drains, via the tank port 23 to the tank 10, the downstream pressure of the directional control valve 15 that acts on the pressure compensation valve 14. Thus, the solenoid relief valve 16 forces the pressure compensation valve 14 to close.

### Relief Valve

The pair of relief valves 17, 18 are connected to supply/drainage channels 32, 33 which connect the directional control valve 15 and the supply/drainage ports 25, 26. The pair of relief valves 17, 18 drain, to the tank 10, the working fluid flowing in the block body 11. More specifically, the first relief valve 17 is connected to a first supply/drainage channel 32 which connects the directional control valve 15 and the first supply/drainage port 25. When the hydraulic pressure in the first supply/drainage channel 32 becomes a predetermined pressure or higher, the first relief valve 17 connects the first supply/drainage channel 32 to the first tank port 23. The second relief valve 18 is connected to the second supply/drainage channel 33 which connects the directional control valve 15 and the second supply/drainage port 26. When the hydraulic pressure in the second supply/drainage channel 33 becomes a predetermined pressure or higher, the second relief valve 18 connects the second supply/drainage channel 33 to the second tank port 24.

### Flow of Working Fluid in Hydraulic Circuit of Valve Block

In the valve block 2, when a control signal is input to the directional control valve 15, the spool 15c moves in a direction corresponding to the control signal. Accordingly, the pressure compensation valve 14 is connected to one of the two ports 25, 26. For example, the pressure compensation valve 14 is connected to the first supply/drainage port 25, and the second supply/drainage port 26 is connected to the tank port 24. Thus, the working fluid introduced through the two inlet ports 21, 22 flows to the merging chambers 31 via the two check valves 12, 13. The working fluid in the merging chamber 31 is brought to the directional control valve 15 from the merging chamber 31 via the pressure compensation valve 14. Subsequently, the working fluid is supplied from the directional control valve 15 to the hydraulic cylinder 9 via the first supply/drainage port 25. With this, the hydraulic cylinder 9 is actuated. At this time, the pressure compensation valve 14 maintains the upstream-downstream pressure difference of the directional control valve 15 at a constant pressure. Furthermore, the directional control valve 15 is controlled so as to have an opening degree corresponding to the control signal. Therefore, the working fluid is brought to the hydraulic cylinder 9 at a flow rate corresponding to the control signal regardless of a load that acts on the hydraulic cylinder 9. With this, it is possible to move the hydraulic cylinder 9 at a speed corresponding to the control signal.

### Structure of Valve Block

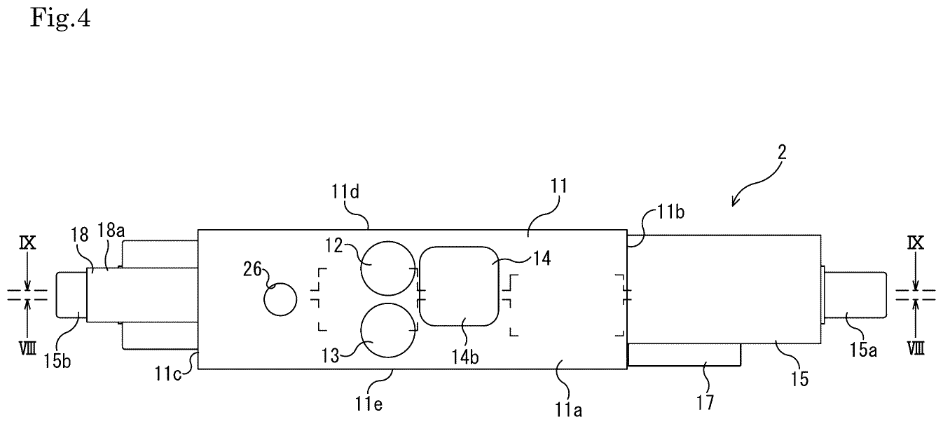

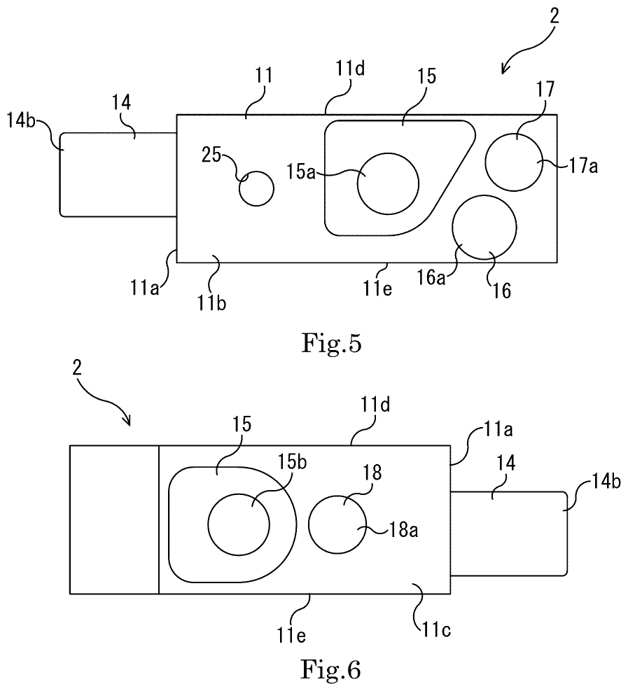

Hereinafter, the structure of the valve block 2 such as the positions of the valves 12 to 18 in the block body 11 will be described. The block body 11 includes first to third side surfaces 11a to 11c, as illustrated in FIG. 2. The first side surface 11a illustrated in FIG. 4 faces one way in a first direction. The second side surface 11b illustrated in FIG. 5 faces one way in a second direction. The third side surface 11c illustrated in FIG. 6 faces the other way in the second direction. The block body 11 further includes a principal surface 11d and a rear surface 11e. The principal surface 11d faces one way in a predetermined direction. The rear surface 11e faces the other way in the predetermined direction. In the present embodiment, the block body 11 is formed in the shape of a rectangular parallelepiped having a thickness in the predetermined direction and elongated in the second direction. The principal surface 11d faces the principal surface of the adjacent valve block 3 (not illustrated in the drawings) in the multi-control valve device 1. Furthermore, in the block body 11, a portion of the third side surface 11c that is located at the other end in the first direction is cut out. This results in a reduced weight of the block body 11.

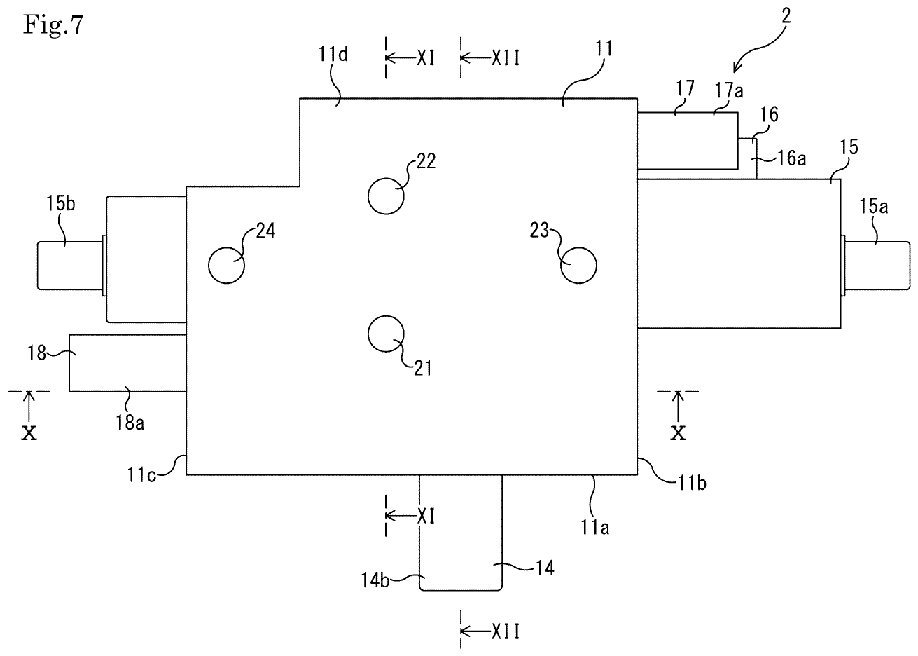

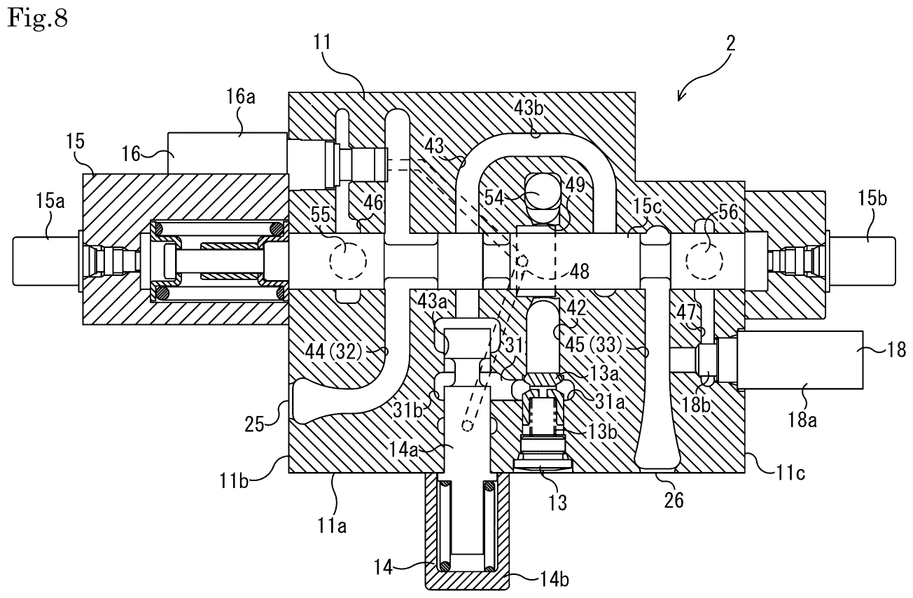

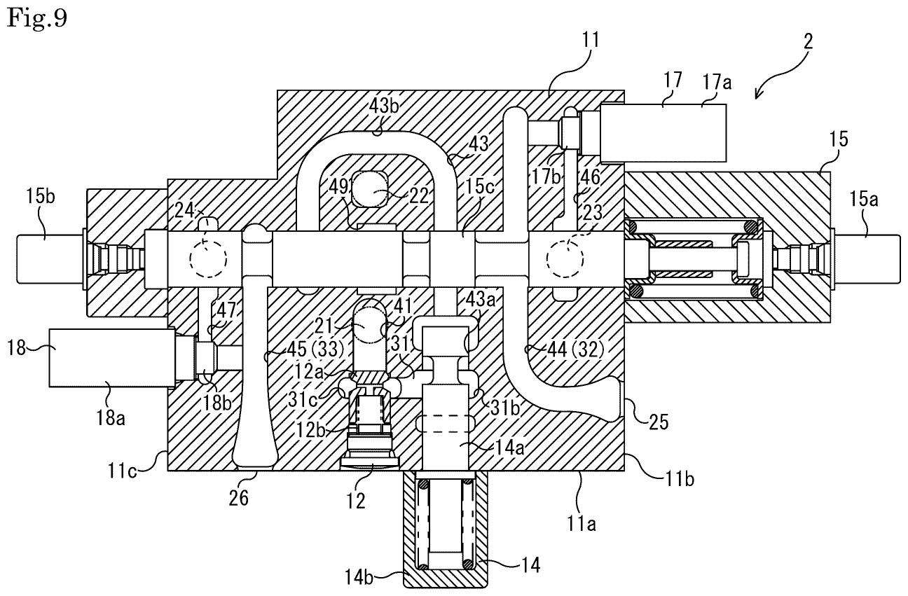

As illustrated in FIG. 7, the first and second inlet ports 21, 22 are formed on the principal surface 11d. More specifically, the first and second inlet ports 21, 22 are formed at portions of the principal surface 11d that are located in the middle in the second direction, and are spaced apart from each other in the first direction. In the present embodiment, the first and second inlet ports 21, 22 are arranged closer to the other end than to one end in the first direction on the principal surface 11d. The adjacent valve block 3 includes two supply ports (not illustrated in the drawings) arranged corresponding to the two inlet ports 21, 22. Therefore, when the valve block 2 and valve block 3 are arranged in the predetermined direction so as to be adjacent to each other, the two inlet ports 21, 22 are connected to the two supply ports. As a result, the two pumps 8L, 8R are connected to the inlet ports 21, 22. Furthermore, in the block body 11, inlet-end passages 41, 42 extend from the two inlet ports 21, 22, as illustrated in FIG. 8 and FIG. 9. The inlet-end passages 41, 42 are bent in an L shape from the inlet ports 21, 22 and then extend on one side in the first direction.

The first and second tank ports 23, 24 are formed on the principal surface 11d. More specifically, the first and second tank ports 23, 24 are arranged closer to the other end than to one end in the first direction and spaced apart from each other in the second direction on the principal surface 11d. In the present embodiment, the first tank port 23 and the second tank port 24 are arranged on one side and the other side, respectively, in the second direction with respect to the line connecting the two inlet ports 21, 22. The first and second tank ports 23, 24 are arranged so as to overlap the directional control valve 15 in a plan view as seen in the predetermined direction. The two tank ports 23, 24 are arranged so as to correspond to two tank communication ports (not illustrated in the drawings) formed in the valve block 3. Therefore, when the valve block 2 and the valve block 3 are arranged in the predetermined direction so as to be adjacent to each other, the two tank ports 23, 24 are connected to the tank 10 via the two tank communication ports.

The first supply/drainage port 25 is formed on the second side surface 11b, as illustrated in FIG. 5. More specifically, the first supply/drainage port 25 is formed on one side in the first direction on the second side surface 11b. The second supply/drainage port 26 is formed on the first side surface 11a. More specifically, the second supply/drainage port 26 is formed on the other side in the second direction on the first side surface 11a. The two supply/drainage ports 25, 26 are connected to the head-end port 9a and the rod-end port 9b of the hydraulic cylinder 9, respectively, via piping not illustrated in the drawings.

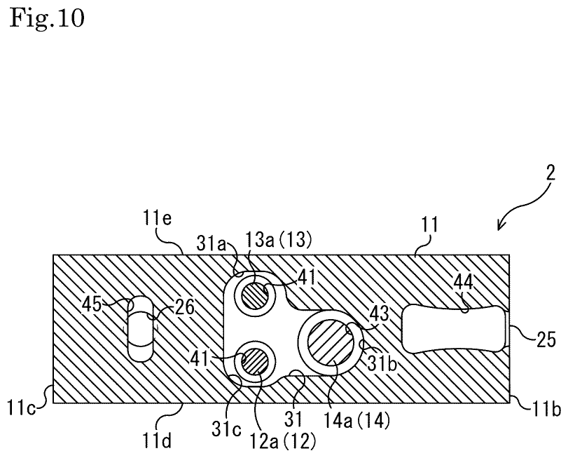

The merging chamber 31 is located on the first side surface 11a side in the block body 11, as illustrated in FIG. 8 and FIG. 9. The merging chamber 31, which is low-profile in the present embodiment, is disposed parallel to the first side surface 11a. The merging chamber 31 is formed so as to have an L-shaped cross-section as viewed from the other side in the first direction, as illustrated in FIG. 10. More specifically, the merging chamber 31 is formed in the shape of an L extending on the other side in the predetermined and on one side in the second direction. The merging chamber 31 is located before the inlet ports 21, 22 (that is, on one side in the first direction) as viewed from the front. Specifically, a portion of the merging chamber 31 is cut out on the other side in the predetermined direction and on one side in the second direction as viewed from the front. The inlet-end passages 41, 42 and a control valve passage 43 are connected to both end portions 31a, 31b and a bent portion 31c of the merging chamber 31. In the present embodiment, the inlet-end passages 41, 42 are connected to the bent portion 31a and the end portion 31a on the other side in the predetermined direction of the merging chamber 31, and the control valve passage 43 is connected to the end portion 31b on one side in the second direction of the merging chamber 31. Note that the control valve passage 43, which is connected to the directional control valve 15, extends on the other side in the first direction from the merging chamber 31.

As illustrated in FIG. 4, the two check valves 12, 13 and the pressure compensation valve 14 are inserted through the first side surface 11a so as to be parallel to each other. More specifically, the first check valve 12 is disposed so as to be adjacent to the pressure compensation valve 14 in the second direction. The second check valve 13 is disposed so as to be adjacent to the first check valve 12 in the predetermined direction. Therefore, the two check valves 12, 13 and the pressure compensation valve 14 are disposed in an L shape as with the merging chamber 31. Note that the first check valve 12 is disposed on the other side of the pressure compensation valve 14 in the second direction in the present embodiment. The second check valve 13 is disposed on the other side of the first check valve 12 in the predetermined direction in the present embodiment.

The two check valves 12, 13 and the pressure compensation valve 14 extend on the other side in the first direction from the first side surface 11a. The two check valves 12, 13 and the pressure compensation valve 14 are disposed as follows relative to the merging chamber 31. Specifically, the two check valves 12, 13 and the pressure compensation valve 14 are disposed at the both end portions 31a, 31b and the bent portion 31c of the merging chamber 31, as illustrated in FIG. 10. More specifically, the first check valve 12 is inserted through the bent portion 31c of the merging chamber 31, and the second check valve 13 is inserted through the end portion 31a of the merging chamber 31 that is located on the other side in the predetermined direction. The pressure compensation valve 14 is inserted through the end portion 31b of the merging chamber 31 that is on one side in the second direction. The configurations of the two check valves 12, 13 and the pressure compensation valve 14 will be described in detail below.

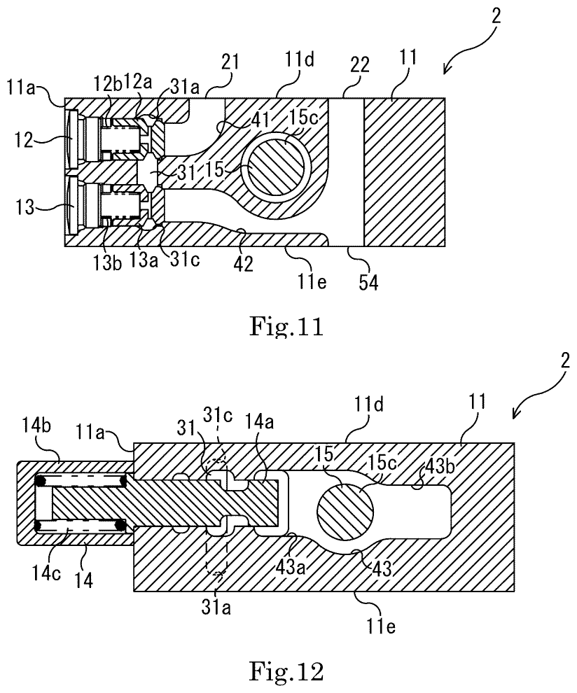

The two check valves 12, 13 include valve bodies 12a, 13a, as illustrated in FIG. 11. The valve bodies 12a, 13a are located at leading ends of the two check valves 12, 13 that are distant on the other side in the first direction from the first side surface 11a. More specifically, in the merging chamber 31, the valve bodies 12a, 13a are arranged corresponding to the openings of the inlet-end passages 41, 42. The valve bodies 12a, 13a are biased by springs 12b, 13b and close the openings of the inlet-end passages 41, 42. Furthermore, the valve bodies 12a, 13a receive, at leading ends thereof, the hydraulic pressure in the corresponding inlet-end passages 41, 42 and the hydraulic pressure in the merging chamber 31 in directions against each other. Thus, the two check valves 12, 13 allow the working fluid to flow to the merging chamber 31 in one direction, and block the working fluid from flowing in the opposite direction.

The pressure compensation valve 14 includes a valve body 14a and a casing 14b, as illustrated in FIG. 12. The valve body 14a is inserted through the first side surface 11a and extends on the other side in the first direction. A leading end portion of the valve body 14a is inserted to the control valve passage 43 through the merging chamber 31. Thus, the valve body 14a closes the control valve passage 43 with the leading end portion and receives the upstream pressure of the directional control valve 15 at the leading end portion. A base end portion of the valve body 14a protrudes from the first side surface 11a. The casing 14b is attached to the first side surface 11a so as to cover the base end portion of the valve body 14a. A spring 14c is housed in the casing 14b. The downstream pressure of the directional control valve 15 is brought to the casing 14b via a downstream pressure introduction passage 48 to be described in detail later and an internal passage located inside the valve body 14a that is not illustrated in the drawings. Therefore, the biasing force of the spring 14c and the downstream pressure act on the valve body 14a in a direction against the upstream pressure of the directional control valve 15. Accordingly, the valve body 14a moves to a position at which the upstream pressure, the downstream pressure, and the biasing force of the spring 14c come into balance. As a result, the opening degree of the pressure compensation valve 14 is adjusted to an opening degree corresponding to the upstream-downstream pressure difference of the directional control valve 15; thus, the upstream-downstream pressure difference of the directional control valve 15 is adjusted to a constant pressure corresponding to the biasing force of the spring 14c.

The directional control valve 15 is inserted through the second side surface 11b of the block body 11, as illustrated in FIG. 8 and FIG. 9. More specifically, the directional control valve 15 penetrates the block body 11 from the second side surface 11b to the third side surface 11c in the second direction. In the present embodiment, the spool 15c extends from the second side surface 11b to the third side surface 11c in the second direction in the block body 11. In the directional control valve 15, the spool 15c is disposed so as to overlap the two tank ports 23, 24 in a plan view. The directional control valve 15 protrudes on one side in the second direction from the second side surface 11b. Furthermore, the directional control valve 15 protrudes on the other side in the second direction from the third side surface 11c. The directional control valve 15 includes solenoid proportional control valves 15a, 15b at the portions protruding from the second side surface 11b and the third side surface 11c. Each of the solenoid proportional control valves 15a, 15b outputs a pilot pressure corresponding to an input control signal. With this, the spool 15c moves on one side and the other side in the second direction.

The control valve passage 43, the two supply/drainage passages 44, 45, the two tank passages 46, 47, and the downstream pressure introduction passage 48 are connected to the directional control valve 15. The control valve passage 43 is connected to a portion of the directional control valve 15 that is located in the middle in the second direction. More specifically, the control valve passage 43 includes a communication portion 43a and an extended portion 43b. The communication portion 43a connects the pressure compensation valve 14 and the directional control valve 15 in the block body 11. The extended portion 43b extends further on the other side in the first direction from the directional control valve 15 in the block body 11. The extended portion 43b is formed in an inverted U shape in a plan view. In other words, the extended portion 43b turns back toward the directional control valve 15. Furthermore, the extended portion 43b is connected to the directional control valve 15 on the other side of the communication portion 43a in the second direction. The second inlet port 22 is disposed inward of the extended portion 43b in a plan view.

The two supply/drainage passages 44, 45 are formed outward of the control valve passage 43 in the second direction in the block body 11. The first supply/drainage passage 44 extends on one side and the other side in the first direction from the directional control valve 15. Note that the first supply/drainage passage 44 is a portion of the first supply/drainage channel 32, that is, a portion of the first supply/drainage channel 32 that is formed on the block body 11. The first supply/drainage passage 44 is bent on one side in the first direction toward the second side surface 11b and is connected to the first supply/drainage port 25. The second supply/drainage passage 45 extends on one side in the first direction from the directional control valve 15 and is connected to the second supply/drainage port 26. Note that the second supply/drainage passage 45 is a portion of the second supply/drainage channel 33, that is, a portion of the second supply/drainage channel 33 that is formed on the block body 11.

The two tank passages 46, 47 are formed outward of the two supply/drainage passages 44, 45 in the second direction in the block body 11. The two tank passages 46, 47 extend from the directional control valve 15 toward the principal surface 11d (that is, on one side in the predetermined direction) and are connected to the two tank ports 23, 24. More specifically, the two tank passages 46, 47 are formed so as to overlap the tank ports 23, 24 in a plan view. The first tank passage 46 is located on the second side surface 11b side in the block body 11 and extends further from the directional control valve 15 on the other side in the first direction. The second tank passage 47 is located on the third side surface 11c side in the block body 11 and extends further from the directional control valve 15 on one side in the first direction.

The downstream pressure introduction passage 48 illustrated in FIG. 8 is connected to a portion of the directional control valve 15 that is located in the middle in the second direction. The downstream pressure introduction passage 48 is formed on the rear surface 11e side of the directional control valve 15 in the block body 11 and extends in the first direction. Therefore, the downstream pressure introduction passage 48 is formed so as to overlap the directional control valve 15 and other passages such as the control valve passage 43 in the block body 11 as viewed from the rear. A more detailed description will be made with respect to the downstream pressure introduction passage 48; in the block body 11, a loop space 49 is formed around the spool 15c on the portion of the directional control valve 15 that is located in the middle in the second direction. The loop space 49 is connected to the supply/drainage passages 44, 45 via internal passages of the spool 15c that are not illustrated in the drawings. Thus, the downstream pressure of the directional control valve 15 is introduced into the loop space 49. The downstream pressure introduction passage 48 rises from the loop space 49 toward the rear surface 11e. At the leading end of the rising portion, the downstream pressure introduction passage 48 is divided into branches extending on one side in the first direction and on the other side in the first direction. The downstream pressure introduction passage 48 is connected to the pressure compensation valve 14 (the casing 14b in the present embodiment) on one side in the first direction. Therefore, the downstream pressure introduction passage 48 supplies the downstream pressure to the pressure compensation valve 14. Note that a portion of the downstream pressure introduction passage 48 that is located on one side in the first direction passes through the cut-out portion of the merging chamber 31. On the other side in the first direction, the downstream pressure introduction passage 48 is inclined toward the second side surface 11b.

Furthermore, although not described in detail, a pressure source passage and a drain passage (not illustrated in the drawings) formed on the block body 11 are connected to the solenoid proportional control valves 15a, 15b of the directional control valve 15. The pressure source passage is connected to a pilot pressure source such as a pilot pump not illustrated in the drawings, and supplies the pilot pressure source to the solenoid proportional control valves 15a, 15b. The drain passage connects the solenoid proportional control valves 15a, 15b to a drain (that is, the tank 10).

The solenoid relief valve 16 is attached to the second side surface 11b, as illustrated in FIG. 5. More specifically, the solenoid relief valve 16 is disposed on the other side of the directional control valve 15 in the first direction on the second side surface 11b. The solenoid relief valve 16 is disposed on the second side surface 11b, closer to the other end (that is, on the rear surface 11e side) than to one end in the predetermined direction. The solenoid relief valve 16 is inserted through the second side surface 11b, as illustrated in FIG. 8. The solenoid relief valve 16 extends on the other side in the second direction. The solenoid relief valve 16 is connected, at a leading end portion thereof, to a portion of the downstream pressure introduction passage 48 that is located on the other side in the first direction. The solenoid relief valve 16 is connected, at a middle portion thereof, to the tank port 23 via the first tank passage 46. The solenoid relief valve 16 includes a solenoid 16a at a portion protruding on one side in the second direction from the second side surface 11b. When a relief signal is input to the solenoid 16a, the valve body of the solenoid relief valve 16, which is not illustrated in the drawings, moves. As a result, the downstream pressure introduction passage 48 and the first tank port 23 are connected. Therefore, the downstream pressure can be set to a tank pressure.

The pair of relief valves 17, 18 are attached to the second side surface 11b and the third side surface 11c, respectively, as illustrated in FIG. 5 and FIG. 6. More specifically, the first relief valve 17 is disposed on the other side of the directional control valve 15 in the first direction on the second side surface 11b, as illustrated in FIG. 5. The first relief valve 17 is disposed on the second side surface 11b, closer to one end (that is, on the principal surface 11d side) than to the other end in the predetermined direction. More specifically, the first relief valve 17 is disposed so as to be adjacent to the solenoid relief valve 16 on the second side surface 11b. The first relief valve 17 is inserted to the second side surface 11b, as illustrated in FIG. 9. The first relief valve 17 extends on the other side in the second direction. The first relief valve 17 is connected to a portion of the first supply/drainage passage 44 that is located on the other side in the first direction. The first relief valve 17 is connected to the tank port 23 via the first tank passage 46. The first relief valve 17 includes a spring not illustrated in the drawings, on the casing 17a protruding on one side in the second direction from the second side surface 11b. The valve body 17b of the first relief valve 17, which is biased by the spring, closes the first supply/drainage passage 44. When the hydraulic pressure in the first supply/drainage passage 44 becomes a predetermined pressure or higher, the valve body 17b is lifted. Accordingly, the first supply/drainage passage 44 is opened, and thus the first supply/drainage passage 44 and the first tank port 23 are connected. As a result, the hydraulic pressure in the first supply/drainage passage 44 is maintained at less than a predetermined pressure.

The second relief valve 18 is disposed on one side of the directional control valve 15 in the first direction on the third side surface 11c, as illustrated in FIG. 6. More specifically, the second relief valve 18 is inserted to the third side surface 11c, as illustrated in FIG. 9. The second relief valve 18 extends on one side in the second direction. The second relief valve 18 is connected to the second supply/drainage passage 45. The second relief valve 18 is connected to the tank port 23 via the second tank passage 47. Furthermore, the second relief valve 18 includes a spring not illustrated in the drawings, on the casing 18a protruding on one side in the second direction from the third side surface 11c. The valve body 18b of the second relief valve 18, which is biased by the spring, closes the second supply/drainage passage 45. When the hydraulic pressure in the second supply/drainage passage 45 becomes a predetermined pressure or higher, the valve body 17b is lifted. Accordingly, the first supply/drainage passage 44 is opened, and thus the second supply/drainage passage 45 and the second tank port 24 are connected. As a result, the hydraulic pressure in the second supply/drainage passage 45 is maintained at less than a predetermined pressure.

In the valve block 2 according to the present embodiment, the first check valve 12, the second check valve 13, and the pressure compensation valve 14 are inserted through the first side surface 11a of the block body 11 so as to be parallel to each other. Therefore, the block body 11 can be made compact in the predetermined direction. Furthermore, the first check valve 12, the second check valve 13, and the pressure compensation valve 14 are kept from interfering with the valve block 3 adjacent thereto in the predetermined direction.

Furthermore, in the valve block 2 according to the present embodiment, the first check valve 12, the second check valve 13, and the pressure compensation valve 14 are arranged so as to be adjacent to each other on the first side surface 11a. Therefore, on the first side surface 11a, the first check valve 12, the second check valve 13, and the pressure compensation valve 14 can be disposed in a compact area.

Furthermore, in the valve block 2 according to the present embodiment, the first inlet port 21 and the second inlet port 22 are formed on the principal surface 11d. Therefore, the two inlet ports 21, 22 are disposed so as to face the adjacent valve block 3. As a result, by forming, on the adjacent valve block 3, ports corresponding to the two inlet ports 21, 22, it is possible to easily connect these ports and the inlet ports 21, 22. Therefore, there is no need to provide another piping or the like at the time of connecting the two inlet ports 21, 22 to these ports, meaning that the number of components of the valve block 2 is reduced.

Furthermore, in the valve block 2 according to the present embodiment, the directional control valve 15 is inserted through the second side surface 11b different from the first side surface 11a. Therefore, the available area of the first side surface 11a is large, meaning that it is possible to improve positioning flexibility for the first check valve 12, the second check valve 13, and the pressure compensation valve 14. Moreover, it is possible to improve flexibility for the passages 41, 42, 43 which are connected to the first check valve 12, the second check valve 13, and the pressure compensation valve 14.

Furthermore, in the valve block 2 according to the present embodiment, the tank ports 23, 24 are formed on the principal surface 11d. Therefore, the tank ports 23, 24 can be connected to the tank 10 via the tank passages (not illustrated in the drawing) formed on the adjacent valve block 3. Therefore, it is not necessary to directly connect the tank ports 23, 24 to the tank 10 through piping. Thus, the number of components of the valve block 2 is reduced.

Furthermore, in the valve block 2 according to the present embodiment, the first supply/drainage port 25 is formed on the second side surface 11b, and the second supply/drainage port 26 is formed on the first side surface 11a. Therefore, it is possible to improve the design flexibility of piping that is connected to the two supply/drainage ports 25, 26.

Furthermore, in the valve block 2 according to the present embodiment, the solenoid relief valve 16 is attached to the second side surface 11b from which the directional control valve 15 protrudes. Therefore, the length of the valve block 2 in the second direction can be reduced by reducing the size of a portion of the solenoid relief valve 16 that protrudes from the second side surface 11b.

Furthermore, in the valve block 2 according to the present embodiment, the pair of relief valves 17, 18 are attached to the second side surface 11b and the third side surface 11c from which the directional control valve 15 protrudes. Therefore, the length of the valve block 2 in the second direction can be reduced by reducing the sizes of portions of the pair of relief valves 17, 18 that protrude from the second side surface 11b and the third side surface 11c.

Furthermore, in the valve block 2 according to the present embodiment, the first relief valve 17 and the solenoid relief valve 16 are disposed on the second side surface 11b, and the second relief valve 18 is disposed on one side in the first direction on the third side surface 11c. Therefore, it is possible to eliminate the need for valves to be disposed on a portion of the second side surface 11b that is located on the other side in the first direction. Accordingly, it is possible to cut out the portion of the second side surface 11b that is located on the other side in the first direction, meaning that the weight of the block body 11 can be reduced.

Furthermore, in the valve block 2 according to the present embodiment, the two check valves 12, 13 are connected to the merging chamber 31 and allow the working fluid to flow in one direction to the merging chamber 31. Therefore, streams of the working fluid flowing to the two check valves 12, 13 merge together in the merging chamber 31 and then, the working fluid flows to the pressure compensation valve 14. Thus, the merging chamber 31 can reduce the pressure loss that may occur when the streams of the working fluid from the two check valves 12, 13 merge together. Furthermore, at the time of casting the valve block 2, the merging chamber can be easily formed as compared to passages.

Moreover, in the valve block 2 according to the present embodiment, the first check valve 12, the second check valve 13, and the pressure compensation valve 14 extend in the predetermined direction, and are disposed at the both end portions 31a, 31b and the bent portion 3 1c of the merging chamber 31 having an L-shaped cross-section. Therefore, the first check valve 12, the second check valve 13, and the pressure compensation valve 14 are disposed in a compact area, and the merging chamber 31 is made compact.

With the multi-control valve device 1 according to the present embodiment, it is possible to implement the multi-control valve device 1 including the aforementioned functions.

### Other Embodiments

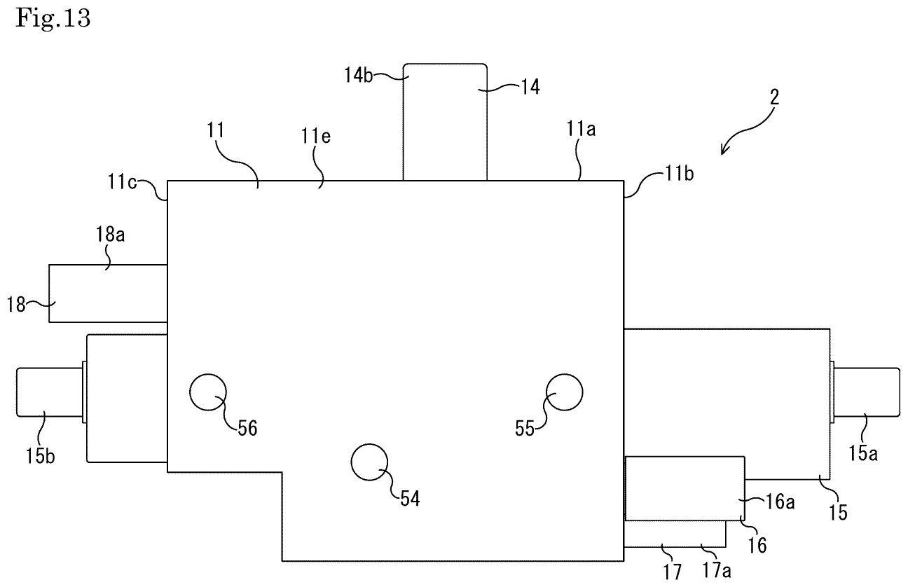

The valve block 2 does not necessarily need to include all the six valves 12 to 18 including the two check valves 12, 13 and the pressure compensation valve 14. Specifically, it is sufficient that the valve block 2 include at least the two check valves 12, 13 and the pressure compensation valve 14. Furthermore, in the valve block 2, the positioning of the solenoid relief valve 16 and the pair of relief valves 17, 18 is not limited to that described above. Moreover, in the valve block 2, the merging chamber 31 does not necessarily need to be included. In other words, the two check valves 12, 13 may be connected through a channel. Note that in the valve block 2, the positions of the ports 21 to 26 are not limited to the aforementioned positions either. Furthermore, in the valve block 2, in order to place another valve block on the other side in the predetermined direction, various ports 54 to 56 to be connected to ports of the other valve block may be formed on the rear surface 11e (refer to FIG. 13).

From the foregoing description, many modifications and other embodiments of the present invention would be obvious to a person having ordinary skill in the art. Therefore, the foregoing description should be interpreted only as an example and is provided for the purpose of teaching the best mode for carrying out the present invention to a person having ordinary skill in the art. Substantial changes in details of the structures and/or functions of the present invention are possible within the spirit of the present invention.

1. A valve block in a multi-control valve device in which a plurality of valve blocks are arranged in a predetermined direction, the valve block comprising:
a block body;
a first check valve and a second check valve each of which allows a working fluid flowing in the block body to flow in one direction and blocks the working fluid from flowing in an opposite direction; and
a pressure compensation valve that compensates for a pressure of the working fluid flowing in the block body, wherein:
the block body includes a first side surface facing one way in a first direction perpendicular to the predetermined direction; and
the first check valve, the second check valve, and the pressure compensation valve are inserted through the first side surface of the block body so as to be parallel to each other.

2. The valve block according to claim 1, wherein:
the first check valve is disposed adjacent to the pressure compensation valve in a second direction perpendicular to the predetermined direction and crossing the first direction; and
the second check valve is disposed adjacent to the first check valve in the predetermined direction.

3. The valve block according to claim 1, wherein:
the block body further includes a principal surface facing one way in the predetermined direction, a first inlet port connected to the first check valve, and a second inlet port connected to the second check valve; and
the first inlet port and the second inlet port are formed on the principal surface of the block body.

4. The valve block according to claim 1, further comprising:
a directional control valve that controls a flow direction of the working fluid flowing in the block body, wherein:
the block body further includes a second side surface facing one way in a second direction perpendicular to the predetermined direction and crossing the first direction; and
the directional control valve is inserted through the second side surface of the block body.

5. The valve block according to claim 4, wherein:
the block body further includes: a principal surface facing one way in the predetermined direction; and a tank port connected to the directional control valve; and
the tank port is formed on the principal surface of the block body.

6. The valve block according to claim 4, wherein:
the block body further includes: a third side surface facing the other way in the second direction; and a first supply/drainage port and a second supply/drainage port connected to the directional control valve;
the first supply/drainage port is formed on the second side surface; and
the second supply/drainage port is formed on the first side surface.

7. The valve block according to claim 4, further comprising:
a solenoid relief valve that drains, among an upstream pressure and a downstream pressure of the directional control valve that act on the pressure compensation valve, the downstream pressure to a tank, wherein:
the directional control valve protrudes on one side in the second direction from the second side surface; and
the solenoid relief valve is attached to the second side surface of the block body.

8. The valve block according to claim 4, further comprising:
a pair of relief valves that drain the working fluid flowing in the block body, wherein:
the block body includes a third side surface facing the other way in the second direction;
the directional control valve extends through from the second side surface to the third side surface and protrudes on one side and the other side in the second direction from the second side surface and the third side surface; and
each of the pair of relief valves is attached to a corresponding one of the second side surface and the third side surface.

9. The valve block according to claim 8, further comprising:
a solenoid relief valve that connects, among an upstream pressure and a downstream pressure of the directional control valve that act on the pressure compensation valve, the downstream pressure to a tank, wherein:
a first relief valve that is one of the pair of relief valves is disposed on the other side of the directional control valve in the first direction on the second side surface;
a second relief valve that is the other of the pair of relief valves is disposed on one side of the directional control valve in the first direction on the third side surface; and
the solenoid relief valve is disposed on the other side of the directional control valve in the first direction on the second side surface of the block body.

10. The valve block according to claim 1, wherein:
the block body further includes a merging chamber into which the pressure compensation valve is inserted; and
the first check valve and the second check valve are connected to the merging chamber and allow the working fluid to flow in one direction to the merging chamber.

11. The valve block according to claim 10, wherein:
the merging chamber is formed having an L-shaped cross section as viewed from one side in the first direction; and
the first check valve, the second check valve, and the pressure compensation valve extend on the other side in the first direction and are disposed at both end portions and a bent portion of the merging chamber.

12. A multi-control valve device comprising:
a plurality of valve blocks including the valve block according to claim 1, wherein:
the plurality of valve blocks are arranged in a predetermined direction so as to be adjacent to each other.
